(19) United States
(12) Patent Application Publication
(10) Pub. No.: US 2025/0309471 A1
(43) Pub. Date: Oct. 2, 2025

(54) SEPARATOR FOR SECONDARY BATTERY AND SECONDARY BATTERY INCLUDING THE SAME

(71) Applicant: SK ON CO., LTD., Seoul (KR)

(72) Inventors: Jeong Han KIM, Daejeon (KR); Hye Min KIM, Daejeon (KR); Whee Sung KIM, Daejeon (KR); Dae Yong YEON, Daejeon (KR); Yun Kyung JO, Daejeon (KR)

(21) Appl. No.: 19/090,272

(22) Filed: Mar. 25, 2025

(30) Foreign Application Priority Data
Mar. 27, 2024 (KR) 10-2024-0041627

(51) Int. Cl. H01M 50/451; H01M 50/417; H01M 50/434; H01M 50/443; H01M 50/446; H01M 50/491

(52) U.S. Cl. CPC H01M 50/451; H01M 50/417; H01M 50/434; H01M 50/443; H01M 50/446; H01M 50/491

(57) ABSTRACT

A separator for a secondary battery includes a substrate, and a coating layer formed on a surface of the substrate and including inorganic particles. The separator has a thermal shrinkage coefficient in the range of 5 kPa to 30 kPa. The thermal shrinkage rate, which is defined as a ratio of a TD thermal shrinkage rate of the separator measured after storage at 130° C. for 1 hour to a TD thermal shrinkage rate of the substrate measured after storage at 130° C. for 1 hour, is 0.3 to 0.5.

### CROSS-REFERENCE TO RELATED APPLICATION AND CLAIM OF PRIORITY

This application claims the benefit of priority to Korean Patent Application No. 10-2024 0041627 filed on Mar. 27, 2024, the entire disclosure of which is incorporated by reference herein.

### BACKGROUND OF THE INVENTION

### 1. Field of the Invention

The embodiments of the present application relate to a separator for a secondary battery and a secondary battery including the same, and more specifically, to a separator for a secondary battery which includes a substrate and a coating layer formed thereon, and a secondary battery including the separator.

### 2. Description of the Related Art

A secondary battery is a battery which may be repeatedly charged and discharged. With rapid progress of information and communication, and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as an electric vehicle, etc., as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

The secondary battery may include an electrode assembly including a cathode, an anode and a separator disposed between the cathode and the anode. When repeatedly charging and discharging the secondary battery under high-temperature conditions, deformation of the separator may occur. For example, a difference in shrinkage rates between an MD direction and a TD direction may lead to increased deformation of the separator.

In this case, a short-circuit between the cathode and the anode may occur due to partial damage to the separator, potentially leading to explosion or ignition.

The separator may include a substrate and a coating layer formed on the substrate. Depending on the variation in thermal shrinkage properties between the substrate and the coating layer, thermal damage of the separator may be accelerated.

### SUMMARY OF THE INVENTION

An object of the present disclosure is to provide a separator for a secondary battery having improved thermal, mechanical stability and reliability.

Another object of the present disclosure is to provide a secondary battery having improved thermal, mechanical stability and reliability, which includes the separator.

A separator for a secondary battery according to embodiments of the present disclosure includes: a substrate; and a coating layer formed on a surface of the substrate and including inorganic particles. The separator has a thermal shrinkage coefficient in a range of 5 kPa to 30 kPa, defined by Equation 1 below. A thermal shrinkage rate ratio, defined as a ratio of a TD thermal shrinkage rate of the substrate measured after storage at 130° C. for 1 hour to a TD thermal shrinkage rate of the separator measured after storage at 130° C. for 1 hour, is 0.3 to 0.5.

$$Thermal shrinkage coefficient = \frac{( 0.015 N - 0.01 N ) / {A}_{0}}{( {L}_{11} - {L}_{10} ) / {L}_{0}} \qquad [ Equation 1 ]$$

(in Equation 1, Ao is an initial cross-sectional area (m²) of a separator sample, L₀ is an initial TD length of the separator sample, L₁₀ is a TD length of the separator sample after 0.01N TMA measurement, and Lu is a TD length of the separator sample after 0.015N TMA measurement.)

In some embodiments, L₁₀ and Lu are lengths measured when the sample is TD shrunk with a force of 0.01N and 0.015N to its maximum shrinkage while increasing temperature at a rate of 5° C./min from room temperature in a nitrogen (N₂) atmosphere using a thermomechanical analysis (TMA) device, respectively.

In some embodiments, 0.01N TMA maximum shrinkage defined by Equation 2-1 below may be 15% or less:

$$0.01 N maximum shrinkage ( \% ) = \{ 1 - ( {L}_{10} / {L}_{0} ) \} \times 100 \qquad [ Equation 2 ‐ 1 ]$$

In some embodiments, 0.015N TMA maximum shrinkage defined by Equation 2-2 below may be 10% or less:

$$0.015 N maximum shrinkage ( \% ) = \{ 1 - ( {L}_{11} / {L}_{0} ) \} \times 100 \qquad [ Equation 2 ‐ 2 ]$$

In some embodiments, the thermal shrinkage coefficient may be 8 kPa to 28 kPa.

In some embodiments, the substrate may include a polyethylene resin having a melt flow index (MI) value of 0.05 to 0.3 measured under conditions of 2.16 kg load at 190° C.

In some embodiments, the substrate film may have a TD elongation ratio of 3 times to 8 times.

In some embodiments, the substrate may have a TD thermal shrinkage rate of 20% or less.

In some embodiments, the substrate may have a TD thermal shrinkage rate of 8% to 18%.

In some embodiments, the separator may have a TD thermal shrinkage rate of 12% or less.

In some embodiments, the separator may have a TD thermal shrinkage rate of 3% to 10%.

In some embodiments, the inorganic particles have a median particle diameter (D50) of 0.4 μm to 1 μm.

In some embodiments, the coating layer may have a porosity of 40% to 60%.

In some embodiments, the coating layer may be formed only on one surface of the substrate.

A secondary battery according to embodiments of the present disclosure includes: a cathode and an anode which are repeatedly stacked; and the above-described separator for a secondary battery of interposed between the cathode and the anode.

The separator for a secondary battery according to the above-described embodiments includes the substrate and the coating layer, and may have a thermal shrinkage coefficient within a predetermined range. Within the above range, curling of the separator may be suppressed, while securing improved heat resistance.

In some embodiments, by adjusting the thermal shrinkage rates of the substrate and the coating layer within a predetermined range, the deformation of the separator may be suppressed. Accordingly, overcharging of the secondary battery or battery cell including the separator may be suppressed, and mechanical stability and charge/discharge stability at high temperatures may be further improved.

The secondary battery including the separator of the present disclosure may be widely applied in green technology fields, such as electric vehicles, battery charging stations, as well as solar power generation, wind power generation, and the like, which use the batteries. In addition, the lithium secondary battery including the separator of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating a separator for a secondary battery according to exemplary embodiments; and

FIGS. 2 and 3 are a plan view and a cross-sectional view illustrating a secondary battery according to exemplary embodiments, respectively.

### DETAILED DESCRIPTION OF THE INVENTION

The embodiments disclosed through the present application provide a separator for a secondary battery including a substrate and a coating layer formed thereon. In addition, a secondary battery including the separator is provided.

The exemplary embodiments will be described in more detail with reference to the drawings. However, since the drawings attached to the present disclosure and embodiments only serve to further understand the technical spirit of the present invention, it should not be construed as limited the present invention to such contents illustrated and described in the drawings and the embodiments.

The terms “first,” “second,” “upper portion,” “upper layer,” “lower portion,” “lower layer,” etc. used herein do not designate an absolute position, but are used in a relative sense. For example, the terms are used relatively to designate a different area with respect to a specific reference plane.

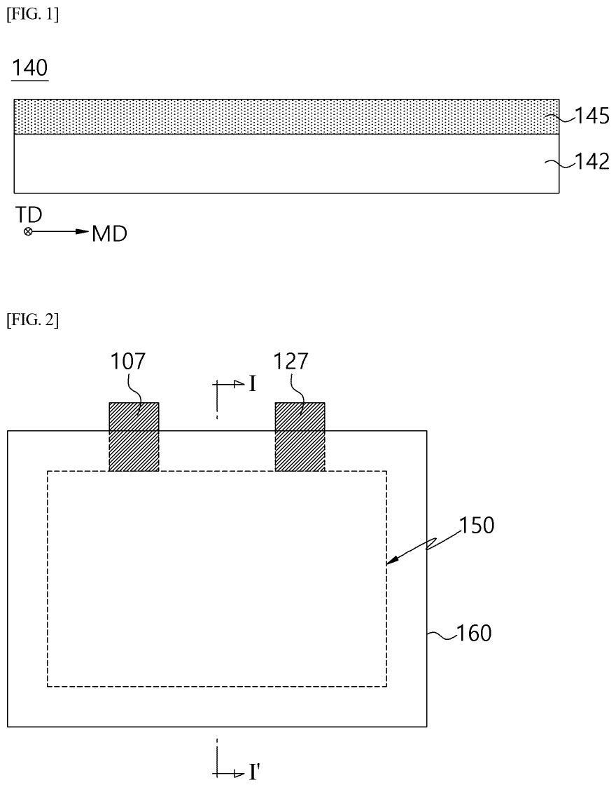

FIG. 1 is a schematic cross-sectional view illustrating a separator for a secondary battery according to exemplary embodiments. The machine direction (MD) shown in FIG. 1 indicates a direction in which a process of preparing the separator is performed, and may correspond to a length direction of the separator. The transverse direction (TD) is a direction perpendicular to the MD, and may correspond to a width direction of the separator.

Referring to FIG. 1, a separator for a secondary battery (hereinafter, abbreviated as a separator) 140 may include a substrate 142 and a coating layer 145 formed on one surface of the substrate 142.

The substrate 142 may include a polyolefin film. For example, the substrate 142 may include a porous polyolefin film. Accordingly, a short-circuit between the cathode and anode through the separator 140 may be blocked, while facilitating ion flow.

For example, the substrate 142 may include a copolymer of two or more of polyethylene, polypropylene, polybutylene, polypentene, polyhexene, polyoctene, ethylene, propylene, butene, pentene, 4-methylpentene, hexene and octene, or a mixture thereof.

Examples of polyethylene may include low-density polyethylene (LDPE), linear low-density polyethylene (LLDPE), high-density polyethylene (HDPE) and the like. In one embodiment, high-density polyethylene with high crystallinity and high melting point of the resin may be used.

In some embodiments, the substrate 142 may further include a resin such as polyether, polyacetal, polyamide, polycarbonate, polyimide, polyamideimide, polyetherimide, etc.

In some embodiments, raw resins of the above-described polyolefin film may be melted and mixed, followed by cooling and cutting to prepare resin pellets. The resin pellets may be extruded at a temperature of 200° C. or higher, for example, using a T-die extruder, to form a resin sheet. The resin sheet may be cooled to prepare a non-elongated sheet.

The substrate 142 may be formed by stretching the non-elongated sheet. The stretching method may include simultaneous biaxial stretching, sequential biaxial stretching, multi-stage stretching, multiple stretching, etc.

In an aspect of securing the strength of the substrate 142, uniformity of film properties, isotropic characteristics, etc., it is possible to form the substrate 142 through simultaneous biaxial stretching.

Simultaneous biaxial stretching may refer to a stretching method in which MD stretching and TD stretching are performed simultaneously, and stretching ratios in each direction may be different from each other.

According to exemplary embodiments, the MD stretching ratio and the TD stretching ratio may be 3 to 8 times, respectively. For example, if the stretching ratio is less than 3 times, non-uniformity in the film properties of the substrate 142 may be increased, and if it is more than 8 times, thermal shrinkage may become excessively high.

In some embodiments, the MID stretching ratio and the TD stretching ratio may be 3 times to 6 times, respectively, and in one embodiment, 3 times to 5 times, or 3 times to 4 times.

In some embodiments, the TD elongation ratio may be adjusted within the above-described range to easily control the thermal shrinkage properties which will be described below. The MD ratio may be appropriately adjusted within a range that does not cause a deterioration in the thermal shrinkage properties.

According to exemplary embodiments, the melt flow index (MI) of the polyolefin resin included in the substrate 142 may be 0.05 to 0.3. Within the above range, sufficient heat resistance may be secured while allowing to easily perform the extrusion process.

In some embodiments, the MI of the polyolefin resin may be 0.05 to 0.25. In one embodiment, the MI of the polyolefin resin may be 0.07 to 0.25, or 0.08 to 0.23. Within the above range, the desired thermal shrinkage properties of the substrate 142 and the separator 140, which will be described below, may be more effectively achieved.

The MI may be measured as a weight extruded with a load of 2.16 kg at 190° C. for 10 minutes. Accordingly, the MI may be expressed in units of grams per 10 minutes (g/10 min).

The coating layer 145 may be formed on one surface of the substrate 142. According to exemplary embodiments, the coating layer 145 may be formed on only one surface of upper and lower surfaces of the substrate 142. In this case, the separator 140 may be provided as a single-sided coating separator.

By using the single-sided coating separator, while securing heat resistance, and ignition and penetration stability of the separator 140 through the coating layer 145, it is possible to prevent a decrease in the capacity of the battery due to an increase in the thickness of the separator 140. For example, by increasing the number of stacks of the cathode and the anode in a limited space, sufficient capacity characteristics may be secured, and an ion transfer distance between the cathode and the anode may be reduced.

However, in the single-sided coating separator, the difference in thermal shrinkage properties between the substrate 142 and the coating layer 145 may be increased compared to a double-sided coating separator. For example, curling may occur due to the difference in the thermal shrinkage rate between the substrate 142 and the coating layer 145, and thickness deformation may easily occur.

According to the embodiments of the present disclosure, as described below, the thermal shrinkage rates of the substrate layer 142 and the coating layer 145 may be adjusted, and the thermal shrinkage coefficient of the entire separator 140 may be controlled, thereby suppressing mechanical failure due to the thermal shrinkage gap of the single-sided coating separator.

The coating layer 145 may include inorganic particles (or ceramic particles). The inorganic particles may include aluminum hydroxide, boehmite, alumina, titania, zirconia, barium sulfate, magnesium oxide, silica and the like. These may be used alone or in combination of two or more thereof.

In some embodiments, the coating layer 145 may not include organic particles (e.g., polyethylene particles).

For example, the inorganic particles may be mixed with a binder in a solvent (e.g., water) to prepare a coating slurry. The coating slurry may be applied to one surface of the substrate 142 and then dried to form the coating layer 145.

Non-limiting examples of the binder may include polymethyl methacrylate, polybutylacrylate, polyvinylidene fluoride-hexafluoropropylene, polyvinyl alcohol (PVA), polyimide, cellulose acetate, carboxymethyl cellulose (CMC) and the like. These may be used alone or in combination of two or more thereof.

A content of the inorganic particles may be 88% by weight (“wt %”) to 99 wt %, based on a solid content of the slurry. In one embodiment, the content of the inorganic particles may be 90 wt % to 96 wt %. Within the above range, while securing sufficient heat resistance, it is possible to prevent an occurrence of excessive thermal shrinkage difference with the substrate 142.

In some embodiments, the inorganic particles may have a median particle diameter (D50) of 0.4 μm to 1 μm. In one embodiment, the inorganic particles may have a median particle diameter (D50) of 0.4 μm or more and less than 1 μm, for example, 0.4 μm to 0.9 μm, or 0.5 μm to 0.9 μm.

Within the above range, while facilitating the formation of a porous structure through the inorganic particles, side reactions with the electrolyte due to an excessive increase in specific surface area may be prevented. In addition, contact/adhesive properties of the substrate 142 may be improved to prevent peeling of the coating layer 145 at a high temperature.

The term “median particle diameter (D50)” as used herein may refer to the mean diameter of the particles at a point corresponding to 50% in a cumulative distribution (distribution based on the number of particles) where the pores are arranged in order of size.

In some embodiments, the coating layer 145 may have a porosity of 40% to 60%. In one embodiment, the coating layer 145 may have a porosity of 45% to 55%. Within the above range, excessive thermal shrinkage may be prevented while facilitating ion transfer through the coating layer 145

In exemplary embodiments, the separator 140 may have a total thickness of 5 μm to 30 μm. In some embodiments, the separator 140 may have a total thickness of 10 μm to 20 μm.

The substrate 142 may have a thickness of 4 μm to 25 μm. In some embodiments, the substrate 142 may have a thickness of 9 μm to 15 μm.

The coating layer 145 may have a thickness of 1 μm to 10 μm. In some embodiments, the coating layer 142 may have a thickness of 1 μm to 5 μm, or 3 μm to 5 μm.

According to exemplary embodiments, the substrate 142 may have a TD thermal shrinkage rate of 20% or less. In some embodiments, the substrate 142 may have a TD thermal shrinkage rate of 18% or less, and in one embodiment, 16% or less.

For example, the substrate 142 may have a TD thermal shrinkage rate of 8% to 20%, 8% to 18%, 8% to 16%, 10% to 20%, 10% to 18%, or 10% to 16%.

Within the above range, while securing thermal shrinkage prevention characteristics through the substrate 142, the occurrence of curling or thickness deformation due to the thermal shrinkage difference with the coating layer 145 may be suppressed.

The TD thermal shrinkage rate of the separator 140 may be smaller than the thermal shrinkage rate of the substrate 142. According to exemplary embodiments, the separator 140 may have a TD thermal shrinkage rate of 12% or less. In some embodiments, the separator 140 may have a TD thermal shrinkage rate of 10% or less, 9% or less, 8% or less, or 7% or less.

For example, the separator 140 may have a TD thermal shrinkage rate of 3% to 12%, 3% to 10%, 3% to 9%, 3% to 8%, 3% to 7%, 4% to 12%, 4% to 10%, 4% to 9%, 4% to 8%, or 4% to 7%.

Within the above range, while preventing an occurrence of wrinkles by the coating layer 145, high-temperature deformation of the separator 140 due to the difference in thermal shrinkage with the substrate 142 may be suppressed.

The term “thermal shrinkage rate” as used herein refers to a ratio of the decreased TD length relative to the initial TD length after storage in a chamber at 130° C. for 1 hour.

According to exemplary embodiments, a ratio of the thermal shrinkage rate of the separator 140 to the thermal shrinkage rate of the substrate 142 may be 0.3 to 0.5. If the thermal shrinkage rate is less than 0.3, a thermal shrinkage rate gap between the substrate 142 and the coating layer 145 may increase excessively. Accordingly, curling and deformation of the separator 140 may easily occur under high-temperature conditions, and a rapid temperature rise and ignition of the battery may be caused due to an electrode short-circuit.

If the thermal shrinkage rate ratio exceeds 0.5, the heat resistance improvement by the coating layer 145 may not be sufficiently achieved. Therefore, the high-temperature charging and discharging stability of the battery may degrade.

In some embodiments, the thermal shrinkage rate ratio may be 0.3 to 0.45, 0.31 to 0.45, or 0.32 to 0.45.

The thermal shrinkage coefficient defined by Equation 1 below of the separator 140 according to the embodiments of the present disclosure may be 5 kPa to 30 kPa.

$$Thermal shrinkage coefficient = \frac{( 0.015 N - 0.01 N ) / {A}_{0}}{( {L}_{11} - {L}_{10} ) / {L}_{0}} \qquad [ Equation 1 ]$$

In Equation 1, Ao represents an initial cross-sectional area (m²) of a separator sample (width×thickness of the separator sample). L₀ represents an initial length (TD length) of the separator sample, L₁₀ represents the length of the separator sample after 0.01N TMA measurement, and L₁₁ represents the length of the separator sample after 0.015N TMA measurement.

For example, L₁₀ represents the length measured when the sample is TD shrunk with a force of 0.01N to its maximum shrinkage while increasing temperature at a rate of 5° C./min from room temperature in a nitrogen (N₂) atmosphere using a thermomechanical analysis (TMA) device. L₁₁ represents the length measured when the sample is TD shrunk with a force of 0.015N to its maximum shrinkage while increasing temperature at a rate of 5° C./min from room temperature in a nitrogen (N₂) atmosphere using a thermomechanical analysis (TMA) device.

The value calculated by Equation 1 has a unit of N/m² and may be converted into Pa.

If the thermal shrinkage coefficient defined by Equation 1 is less than 5 kPa, the difference in shrinkage rates between 0.01N TMA and 0.015N TMA increases excessively, leading to an occurrence of dimensional deformation sensitively under high-temperature conditions. Accordingly, the heat resistance and ignition resistance of the separator and the battery may deteriorate.

If the thermal shrinkage coefficient defined by Equation 1 exceeds 30 kPa, the overall shrinkage stress of the separator 140 may increase excessively. Accordingly, mechanical deformation of the battery cell may be caused by the pressure and temperature rise occurring within the battery cell during high-temperature charging and discharging cycles.

In some embodiments, the thermal shrinkage coefficient may be 8 kPa to 28 kPa, 10 kPa to 28 kPa, 15 kPa to 28 kPa, or 20 kPa to 28 kPa.

According to exemplary embodiments, 0.01N TMA maximum shrinkage may be 15% or less. The 0.01N TMA maximum shrinkage may be defined by the Equation 2-1 below.

$$0.01 N maximum shrinkage ( \% ) = \{ 1 - ( {L}_{10} / {L}_{0} ) \} \times 100 \qquad [ Equation 2 ‐ 1 ]$$

In Equation 2-1, L₁₀ and L₀ are as defined in Equation 1 and may be measured under the above-described TMA conditions.

In some embodiments, the 0.01N TMA maximum shrinkage may be 5% to 15%, 5% to 14%, 6% to 14%, or 6% to 12%.

According to exemplary embodiments, 0.015N TMA maximum shrinkage may be 10% or less, or less than 10%. The 0.015N TMA maximum shrinkage may be defined by Equation 2-1 below.

$$0.015 N maximum shrinkage ( \% ) = \{ 1 - ( {L}_{11} / {L}_{0} ) \} \times 100 \qquad [ Equation 2 ‐ 2 ]$$

In Equation 2-2, L₁₁ and L₀ are as defined in Equation 1, and may be measured under the above-described TMA conditions.

In some embodiments, the 0.015N TMA maximum shrinkage may be 9% or less, or 1% to 9%.

When the thermal shrinkage coefficient is adjusted within the above-described maximum shrinkage, the heat resistance and stability of the separator having a single-sided coating structure may be effectively enhanced while reducing the thermal shrinkage gap due to the change in conditions.

The shrinkage-related properties, such as the above-described thermal shrinkage rate, thermal shrinkage coefficient, etc., may be adjusted by the factors described in the present disclosure. Additionally, these properties may also be adjusted by the process conditions (such as drying, coating and stretching speeds, drying, coating and stretching temperatures, etc.) for forming the substrate and coating layer.

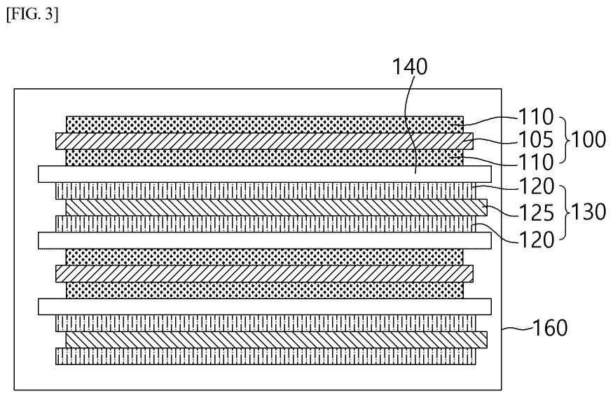

FIGS. 2 and 3 are a schematic plan view and a cross-sectional view illustrating a secondary battery according to exemplary embodiments, respectively. For example, FIG. 3 is a cross-sectional view taken on line I-I′ of FIG. 2 in a thickness direction of the secondary battery.

The secondary battery shown in FIGS. 2 and 3 is schematically illustrated for convenience of description, and the structural configuration of the secondary battery of the present disclosure is not limited to the structure shown in FIGS. 2 and 3.

Referring to FIGS. 2 and 3, the secondary battery includes a cathode 100 and an anode 130 described above, and the separator 140 according to the above-described embodiments of the present disclosure, which is interposed between the cathode 100 and the anode 130. In FIG. 3, the separator 140 is depicted in a single-layer form for convenience of illustration, but as described above with reference to FIG. 1, the separator 140 includes the substrate 142 and the coating layer 145, and may have the single-sided coating structure.

The cathode 100 may include a cathode active material layer 110 formed by applying a cathode active material to a cathode current collector 105. The cathode active material may include a compound capable of reversibly intercalating and deintercalating lithium ions. In this case, the secondary battery may be provided as a lithium secondary battery.

The cathode current collector 105 may include stainless steel, nickel, aluminum, titanium or an alloy thereof. The cathode current collector 105 may also include aluminum or stainless steel subjected to surface treatment with carbon, nickel, titanium or silver.

The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or crystal structure represented by Formula 1 below.

LiₓNiₐM_{b}O_{2+z} [Formula 1]

In Formula 1, x, a, b and z may satisfy 0.9≤x≤1.2, 0.6≤a≤0.99, 0.01≤b≤0.4,−0.5≤z<0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance chemical stability thereof or the layered structure/crystal structure. The auxiliary element may be incorporated into the layered structure/crystal structure together to form a bond, and it should be understood that this case is also included within the chemical structure range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may act as an auxiliary active element which contributes to the capacity/output activity of the cathode active material together with Co or Mn like Al.

For example, the cathode active material or the lithium-nickel metal oxide may include a layered structure or crystal structure represented by Formula 1-1 below.

LiₓNiₐM1_{b1}M2_{b2}O_{2+z} [Formula 1-1]

In Formula 1, M1 may include Co, Mn and/or Al. M2 may include the above-described auxiliary elements. In Formula 1-1, x, a, b1, b2 and z may satisfy 0.9≤×≤1.2, 0.6≤a≤0.99, 0.01≤b1+b2≤0.4, −0.5≤z<0.1 may be satisfied.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may penetrate through the surface of the lithium-nickel metal composite oxide particles to become incorporated into the bonding structure represented by Formula 1 or Formula 1-1 above.

The cathode active material may include a nickel-cobalt-manganese (NCM)-based lithium oxide. In this case, an NCM-based lithium oxide with an increased content of nickel may be used.

Nickel may be provided as a transition metal associated with the output and capacity of the lithium secondary battery. Therefore, as described above, by employing a high-content (High-Ni) composition in the cathode active material, a high-capacity cathode and a high-capacity lithium secondary battery may be provided.

In this regard, as the content of Ni increase, long-term storage stability and lifespan stability of the cathode or the secondary battery may be relatively decreased, and side reactions with the electrolyte may also be increased. However, according to exemplary embodiments, the electrical conductivity may be maintained by including Co, and the lifespan stability and capacity retention characteristics may be improved through Mn.

The content of Ni (e.g., a molar fraction of nickel based on a total number of moles of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may also include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a manganese (Mn)-rich active material, a lithium rich layered oxide (LLO)/over lithiated oxide (OLO)-based active material, or a cobalt (Co)-less active material, which have a chemical structure or crystal structure represented by Formula 2 below.

p[Li₂MnO₃]·(1-p)[Li_{q}JO₂] [Formula 2]

In Formula 2, p and q may satisfy 0<p<1, 0.9≤q≤1.2, and J may include at least one element among Mn, Ni, Co, Fe, Cr, V, Cu, Zn, Ti, Al, Mg and B.

For example, the cathode active material may be mixed in a solvent to prepare a cathode slurry. The cathode current collector 105 may be coated with the cathode slurry, followed by drying and pressing to prepare the cathode active material layer 110.

The cathode active material layer 110 may further include a binder, and may optionally further include a conductive agent, a thickener, etc.

As the binder and the conductive agent for a cathode, materials which are substantially the same as or similar to those of the above-described binder and conductive agent may be used. In some embodiments, polyvinylidene fluoride (PVDF) binder may be used as the binder for a cathode.

The anode 130 may include an anode current collector 125 and an anode active material layer 120.

The anode current collector 155 may include the metals or alloy mentioned in the cathode current collector. In some embodiments, the anode current collector 155 may include copper or a copper alloy.

The anode active material layer 120 may be formed on an upper surface and/or a lower surface of the anode current collector 125. The anode active material layer 120 may be formed on the upper surface and the lower surface, respectively.

The anode active material layer 120 may include an anode active material and an anode binder.

As the anode active material, carbon-based materials such as crystalline carbon, amorphous carbon, carbon composite, carbon fiber, etc.; a lithium alloy; a silicon (Si) compound or tin, etc. may be used.

Examples of the amorphous carbon may include hard carbon, cokes, mesocarbon microbead (MCMB), mesophase pitch-based carbon fiber (MPCF) or the like.

Examples of the crystalline carbon may include graphite-based carbon such as natural graphite, artificial graphite, graphite cokes, graphite MCMB, graphite MPCF or the like.

Other elements included in the lithium alloy may include, for example, aluminum, zinc, bismuth, cadmium, antimony, silicone, lead, tin, gallium or indium, etc.

The silicon compound may include, for example, silicon (Si), silicon oxide (for example, SiOx, 0<x<2) or a silicon-carbon composite compound containing silicon carbide (SIC).

For example, an anode slurry may be prepared by mixing the anode active material with the binder, conductive agent, thickener, and the like in a solvent, followed by stirring. The anode slurry may then be applied to at least one surface of the anode current collector 125, followed by drying and pressing to prepare the anode 130.

As the binder and conductive agent, materials which are substantially the same as or similar to the above-described material used in the cathode active material layer 110 may be used. In some embodiments, the binder for an anode may include, for example, an aqueous binder such as styrene-butadiene rubber (SBR) for consistency with the carbon-based active material, and may be used together with a thickener such as carboxymethyl cellulose (CMC).

According to exemplary embodiments, an electrode cell is defined by the cathode 100, the anode 130 and the separator 140, and a plurality of electrode cells may be stacked to form, for example, an electrode assembly 150. The electrode assembly 150 may be of a winding type, a stacking type, a z-folding type, or a stack-folding type electrode assembly.

In one embodiment, the electrode assembly 150 may be housed within the case 160 together with an electrolyte. According to exemplary embodiments, a non-aqueous electrolyte may be used as the electrolyte.

The non-aqueous electrolyte includes a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻; CF₃CO₂⁻, CH₃CO₂, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane, and the like may be used. These compounds may be used alone or in combination of two or more thereof.

As shown in FIG. 3, electrode tabs (a cathode tabs and an anode tabs) may protrude from each cathode current collector 105 and each anode current collector 125, respectively, which belong to each electrode cell, and may extend to one end portion of the case 160. The electrode tabs may be fused together with the one end portion of the case 160 to be connected with electrode leads (a cathode lead 107 and an anode lead 127) extending or exposed to an outside of the case 160.

In FIG. 3, the cathode lead 107 and the anode lead 127 are shown to protrude from an upper side of the case 160 in a planar direction, but positions of these electrode leads are not limited thereto. For example, the electrode leads may protrude from at least one of both sides of the case 160, or may protrude from a lower side of the case 160. Alternatively, the cathode lead 107 and the anode lead 127 may be formed to protrude from different sides of the case 160, respectively.

The lithium secondary battery may be manufactured, for example, in a cylindrical shape using a can, a square shape, a pouch shape or a coin shape.

The above-described secondary battery may include the separator 140 according to embodiments of the present disclosure. For example, by employing the separator 140 having the single-sided coating structure, the number of stacks of the cathode 100 and the anode 130 may be relatively increased.

Therefore, the capacity of the secondary battery may be further increased in a limited size. In addition, the separator 140 is designed to have the above-described thermal shrinkage properties even in the single-sided coating structure, such that defects such as curling, deformation, and wrinkling may be suppressed, thereby improving the operational stability of the secondary battery even at high-temperature charging and discharging.

Hereinafter, preferable examples are proposed to facilitate understanding of the present disclosure. However, the following examples are only given for illustrating the present disclosure and those skilled in the art will obviously understand that various alterations and modifications are possible within the scope and spirit of the present disclosure. Such alterations and modifications are duly included in the appended claims.

### Examples and Comparative Examples

Pellets prepared using a polyethylene resin having MI values described in Tables 1 and 2 were mixed with oil in a ratio of 3:7 (volume ratio).

The mixture was extruded onto a sheet at 200° C. using a T-die extruder, and then solidified through a cooling roll to prepare a non-elongated sheet.

The non-elongated sheet was TD stretched at 120° C. at the ratios described in Tables 1 and 2 (the MID stretching ratio was commonly 5 times), and then heat set at 130° C. to fabricate substrates.

Boehmite having the median particle diameters (D50) described in Tables 1 and 2 and a polyacrylate binder were mixed with water in the weight ratios described in Tables 1 and 2 to prepare a slurry. The slurry was applied to the substrate and then dried to form coating layers having the porosity values described in Table 1.

The thicknesses of the coating layer and the substrate are as described in Tables 1 and 2.

The MI was measured by applying a load of 21.6 kg at 190° C. for 10 minutes according to the JIS K7210:1999 standard.

The porosity (%) of the coating layer was calculated from the following equation.

Coating layer porosity (%)={1−(Weight of coating layer/Volume of coating layer)/Solid content density of coating layer}×100

The solid content density of the coating layer was calculated by adapting the density of solid components such as inorganic substances and binders, etc., used in the preparation of the slurry to the ratio.

The volume of the coating layer was calculated by measuring the thickness, width, and length of the coating layer.

The thicknesses of the substrate and the coating layer were measured using a thickness measuring device (VL-50S-B, Mitutoyo).

TABLE 1

| | Example 1 | Example 2 | Example 3 | Example 4 | Example 5 |
|---|---|---|---|---|---|
| MI (g/10 | 0.08 | 0.08 | 0.17 | 0.23 | 0.45 |
| min) | | | | | |
| TD | 4 | 4 | 6 | 6 | 7 |
| elongation | | | | | |
| ratio | | | | | |
| Total | 12 | 14 | 16 | 19 | 13 |
| thickness | | | | | |
| (μm) | | | | | |
| Substrate | 9 | 9 | 11 | 14 | 10 |
| thickness | | | | | |
| (μm) | | | | | |
| Coating | 3 | 5 | 5 | 5 | 3 |
| layer | | | | | |
| thickness | | | | | |
| (μm) | | | | | |
| Median | 0.5 | 0.9 | 0.9 | 0.7 | 0.5 |
| particle | | | | | |
| diameter | | | | | |
| of inorganic | | | | | |
| particles | | | | | |
| (μm) | | | | | |
| Ratio of | 96 | 93 | 93 | 90 | 96 |
| inorganic | | | | | |
| particles in | | | | | |
| coating | | | | | |
| layer (wt %) | | | | | |
| Coating | 46.0 | 53.0 | 53.0 | 46 | 46.0 |
| layer | | | | | |
| porosity (%) | | | | | |

TABLE 2

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| MI (g/10 | 0.21 | 0.17 | 0.45 | 0.08 | 0.23 |
| min) | | | | | |
| TD | 11 | 6 | 7 | 4 | 6 |
| elongation | | | | | |
| ratio | | | | | |
| Total | 12 | 16 | 15 | 11 | 19 |
| thickness | | | | | |
| (μm) | | | | | |
| Substrate | 9 | 11 | 10 | 9 | 14 |
| thickness | | | | | |
| (μm) | | | | | |
| Coating | 3 | 5 | 5 | 2 | 5 |
| layer | | | | | |
| thickness | | | | | |
| (μm) | | | | | |
| Median | 0.5 | 0.3 | 0.9 | 0.7 | 0.6 |
| particle | | | | | |
| diameter of | | | | | |
| inorganic | | | | | |
| particles | | | | | |
| (μm) | | | | | |
| Ratio of | 96 | 95 | 93 | 90 | 96 |
| inorganic | | | | | |
| particles in | | | | | |
| coating | | | | | |
| layer (wt %) | | | | | |
| Coating | 46.0 | 44.0 | 53 | 46.0 | 48.0 |
| layer | | | | | |
| porosity (%) | | | | | |

### Measurement of Properties of Separator

### (1) TD Thermal Shrinkage Rate

After the substrate and coating layer were formed, a separator sample (TD length: 30 cm, MD length: 30 cm) was stored in a chamber at 130° C. for 1 hour, and the change in TD length was measured to calculate the thermal shrinkage rate using the following equation.

TD thermal shrinkage rate (%)=[(Initial length-Length after storage)/(Initial length)]×100

(2) TMA thermal shrinkage rate

The separator sample was subjected to shrinkage with a force of 0.01 N and 0.015 N while increasing temperature at a rate of 5° C./min from room temperature in a nitrogen (N₂) atmosphere, then the TD length after maximum shrinkage was measured using TMA equipment (TMA Q400, TA) Using the above-described Equations 2-1 and 2-2, the 0.01 N TMA maximum shrinkage rate and the 0.015 N TMA maximum shrinkage rate were measured, respectively.

### (3) Thermal Shrinkage Coefficient

Using the results measured under the TMA conditions used in the above (2), the thermal shrinkage coefficient was measured using the above-described Equation 1.

The measurement results are shown in Tables 3 and 4 below.

### Experimental Example

### (1) Manufacturing of Secondary Battery

A cathode slurry was prepared by adding 94 wt % of lithium-cobalt oxide as a cathode active material, 2.5 wt % of polyvinylidene fluoride (PVDF) as a binder, and 3.5 wt % of Super-P as a conductive agent to N-methylpyrrolidone (NMP). The cathode slurry was uniformly applied to an aluminum substrate with a thickness of 12 μm, followed by drying and pressing to fabricate a cathode.

An anode slurry was prepared by adding 95 wt % of artificial graphite as a graphite-based active material and 5 wt % of styrene-butadiene rubber (SBR)-carboxymethyl cellulose (CMC) as a binder to water. The anode slurry was uniformly applied to a copper substrate with a thickness of 8 μm, followed by drying and pressing to fabricate an anode.

An electrode assembly was manufactured by notching the cathode and anode to a predetermined size and stacking them with the separators of the examples and comparative examples interposed therebetween.

The electrode assembly was placed in a pouch and sealed on three sides except for an electrolyte injection part. At this time, the portion with electrode tabs was included in the sealing part. An electrolyte was injected through the electrolyte injection part, and the electrolyte injection part was also sealed, and then the assembly was impregnated for 12 more hours to manufacture a 2000 mAh lithium secondary battery.

A 1 M LiPF₆ solution was prepared using a mixed solvent of EC/EMC/DMC (3/5/2; volume ratio) and used as the electrolyte.

### (2) Measurement of Curling Ratio

As described above, when measuring the thermal shrinkage rate, the length at which the curling occurred in the TD direction was measured, and the ratio of the length at which the curling occurred to the total shrinkage length was calculated.

### (3) Evaluation of High-Temperature Storage Characteristics

The secondary battery manufactured in the above (1) was stored at 60° C. for 20 weeks to check whether the pouch was opened.

If the pouch was not opened after 20 weeks of storage, it was evaluated as “o,” and if the pouch was opened, it was evaluated as “X.”

### (3) Overcharge Evaluation

After charging the secondary battery manufactured in the above (1) to 5.5V at 1C, ignition and smoke occurrence were observed for up to 2 hours, and evaluated as follows.

o: No ignition or smoke occurrence

Δ: Partial smoke occurrence

X: Ignition occurrence

### (4) Heat Exposure Evaluation

The secondary battery manufactured in the above (1) was exposed to 140° C. for 1 hour, and the ignition and smoke occurrence were evaluated as follows.

o: No ignition or smoke occurrence

Δ: Partial smoke occurrence

X: Ignition occurrence

The evaluation results are shown together in Tables 3 and 4 below.

TABLE 3

| | Example 1 | Example 2 | Example 3 | Example 4 | Example 5 |
|---|---|---|---|---|---|
| Substrate | 12 | 12 | 16 | 12 | 29 |
| thermal | | | | | |
| shrinkage | | | | | |
| rate (%) | | | | | |
| Separator | 4 | 5 | 7 | 5 | 14 |
| thermal | | | | | |
| shrinkage | | | | | |
| rate (%) | | | | | |
| Separator/ | 0.33 | 0.42 | 0.44 | 0.44 | 0.48 |
| substrate | | | | | |
| thermal | | | | | |
| shrinkage | | | | | |
| rate ratio | | | | | |
| 0.01N TMA | 8 | 9 | 12 | 6 | 21 |
| maximum | | | | | |
| shrinkage | | | | | |
| rate (%) | | | | | |
| 0.015N | 5 | 6 | 9 | 0 | 15 |
| TMA | | | | | |
| maximum | | | | | |
| shrinkage | | | | | |
| rate (%) | | | | | |
| Thermal | 27.8 | 23.8 | 20.8 | 8.8 | 12.8 |
| shrinkage | | | | | |
| coefficient | | | | | |
| (kPa) | | | | | |
| Curling | 4 | 6 | 6 | 4 | 9 |
| ratio (%) | | | | | |
| High- | ◯ | ◯ | ◯ | ◯ | ◯ |
| temperature | | | | | |
| storage | | | | | |
| Overcharge | ◯ | ◯ | ◯ | ◯ | Δ |
| Heat | ◯ | ◯ | ◯ | ◯ | Δ |
| exposure | | | | | |

TABLE 4

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| Substrate | 22 | 16 | 29 | 12 | 12 |
| thermal | | | | | |
| shrinkage | | | | | |
| rate (%) | | | | | |
| Separator | 9 | 4 | 20 | 5 | 7 |
| thermal | | | | | |
| shrinkage | | | | | |
| rate (%) | | | | | |
| Separator/ | 0.41 | 0.25 | 0.69 | 0.42 | 0.58 |
| substrate | | | | | |
| thermal | | | | | |
| shrinkage | | | | | |
| rate ratio | | | | | |
| 0.01N TMA | 18 | 6 | 29 | 11 | 9 |
| maximum | | | | | |
| shrinkage | | | | | |
| rate (%) | | | | | |
| 0.015N | 16 | 3 | 15 | 8 | 7 |
| TMA | | | | | |
| maximum | | | | | |
| shrinkage | | | | | |
| rate (%) | | | | | |
| Thermal | 41.7 | 20.8 | 4.8 | 30.3 | 26.3 |
| shrinkage | | | | | |
| coefficient | | | | | |
| (kPa) | | | | | |
| Curling | 6 | 17 | 4 | 6 | 14 |
| ratio (%) | | | | | |
| High- | ◯ | X | ◯ | ◯ | X |
| temperature | | | | | |
| storage | | | | | |
| Overcharge | ◯ | X | X | X | X |
| Substrate | X | X | X | X | X |
| thermal | | | | | |
| shrinkage | | | | | |
| rate (%) | | | | | |

Referring to Tables 3 and 4, in the examples, where the separator satisfying the above-described range of the separator/substrate thermal shrinkage ratio and thermal shrinkage coefficient was used, curling was suppressed overall, and high temperature and overcharge stability were improved.

In Comparative Example 1, as the elongation ratio of the substrate increased, the thermal shrinkage rate of the substrate increased, and the thermal shrinkage coefficient also increased. Accordingly, ignition of the battery occurred due to heat exposure.

In Comparative Example 2, a coating layer including boehmite having a particle diameter of 0.3 μm was formed, such that the thermal shrinkage rate of the separator was improved, but curling significantly increased as the separator/substrate thermal shrinkage ratio excessively decreased. In addition, the stability of the battery also deteriorated due to an increase in side reactions between components in the coating layer.

In Comparative Example 3, as the MI of the PE resin used in the substrate increased, the thermal shrinkage rate of each of the substrate and the separator also increased. Accordingly, the thermal shrinkage coefficient decreased, but the thermal shrinkage ratio of the separator/substrate increased, leading to deterioration in the stability of the battery.

In Comparative Example 4, where the thermal shrinkage coefficient increased excessively, and Comparative Example 5, where the thermal shrinkage rate increased significantly, both the high temperature and overcharge stability were deteriorated.

In Example 5, as the MI of the PE resin used in the substrate increased, the heat export rate ratio of the separator/substrate increased relatively compared to the other examples. Accordingly, a small amount of gas was observed during the overcharge and heat exposure evaluation.

What is claimed is:

1. A separator for a secondary battery comprising:
a substrate; and
a coating layer formed on a surface of the substrate and comprising inorganic particles,
wherein the separator has a thermal shrinkage coefficient in a range of 5 kPa to 30 kPa, defined by Equation 1 below, and
a thermal shrinkage rate ratio, defined as a ratio of a TD thermal shrinkage rate of the substrate measured after storage at 130° C. for 1 hour to a TD thermal shrinkage rate of the separator measured after storage at 130° C. for 1 hour, is 0.3 to 0.5:
$$Thermal shrinkage coefficient = \frac{( 0.015 N - 0.01 N ) / {A}_{0}}{( {L}_{11} - {L}_{10} ) / {L}_{0}} \qquad [ Equation 1 ]$$
(in Equation 1, Ao is an initial cross-sectional area (m²) of a separator sample, L₀ is an initial TD length of the separator sample, L₁₀ is a TD length of the separator sample after 0.01N TMA measurement, and L₁₁ is a TD length of the separator sample after 0.015N TMA measurement).

2. The separator for a secondary battery according to claim 1, wherein L₁₀ and Lu are lengths measured when the sample is TD shrunk with a force of 0.01N and 0.015N to its maximum shrinkage while increasing temperature at a rate of 5° C./min from room temperature in a nitrogen (N₂) atmosphere using a thermomechanical analysis (TMA) device, respectively.

3. The separator for a secondary battery according to claim 2, wherein 0.01N TMA maximum shrinkage defined by Equation 2-1 below is 15% or less:
$$0.01 N maximum shrinkage ( \% ) = \{ 1 - ( {L}_{10} / {L}_{0} ) \} \times 100. \qquad [ Equation 2 ‐ 1 ]$$

4. The separator for a secondary battery according to claim 2, wherein 0.015N TMA maximum shrinkage defined by Equation 2-2 below is 10% or less:
$$0.015 N maximum shrinkage ( \% ) = \{ 1 - ( {L}_{11} / {L}_{0} ) \} \times 100. \qquad [ Equation 2 ‐ 2 ]$$

5. The separator for a secondary battery according to claim 1, wherein the thermal shrinkage coefficient is 8 kPa to 28 kPa.

6. The separator for a secondary battery according to claim 1, wherein the substrate comprises a polyethylene resin having a melt flow index (MI) value of 0.05 to 0.3 measured under conditions of 2.16 kg load at 190° C.

7. The separator for a secondary battery according to claim 1, wherein the substrate film has a TD elongation ratio of 3 times to 8 times.

8. The separator for a secondary battery according to claim 1, wherein the substrate has a TD thermal shrinkage rate of 20% or less.

9. The separator for a secondary battery according to claim 1, wherein the substrate has a TD thermal shrinkage rate of 8% to 18%.

10. The separator for a secondary battery according to claim 1, wherein the separator has a TD thermal shrinkage rate of 12% or less.

11. The separator for a secondary battery according to claim 1, wherein the separator has a TD thermal shrinkage rate of 3% to 10%.

12. The separator for a secondary battery according to claim 1, wherein the inorganic particles have a median particle diameter (D50) of 0.4 μm to 1 μm.

13. The separator for a secondary battery according to claim 1, wherein the coating layer has a porosity of 40% to 60%.

14. The separator for a secondary battery according to claim 1, wherein the coating layer is formed only on one surface of the substrate.

15. A secondary battery comprising:
a cathode and an anode which are repeatedly stacked; and
the separator for a secondary battery of claim 1 interposed between the cathode and the anode.
